(19) United States
(12) Patent Application Publication
(10) Pub. No.: US 2009/0313007 A1
(43) Pub. Date: Dec. 17, 2009

(54) SYSTEMS AND METHODS FOR AUTOMATED VOICE TRANSLATION

(76) Inventors: Ajay Bajaj, Belle Mead, NJ (US); Ronald O. Brown, Casco, ME (US); Louis A. Lombardi, Middletown, NJ (US); Uma S. Pandey, Belle Mead, NJ (US)

Correspondence Address: KENYON & KENYON LLP, ONE BROADWAY, NEW YORK, NY, 10004, US

(21) Appl. No.: 12/139,211

(22) Filed: Jun. 13, 2008

(51) Int. Cl. G06F 17/28

(52) U.S. Cl. 704/3

(57) ABSTRACT

The present invention relates to a telecommunications system including first and second telecommunications devices, and a computing device. The first telecommunications device is configured to receive audio input from and deliver audio output to a first user. The second telecommunications device is configured to receive audio input from and deliver audio output to a second user. The computing device is configured to deliver a set of computer-readable instructions upon request to the second telecommunications device, the instructions configured to, when executed, convert audio input received from the first user at the first device in a first human language into audio output for delivery to the second user at the second device in a second human language, the first and second languages being different.

### BACKGROUND

Automatic translation services that convert written text from one language to another have been described. Translation services that convert speech input in one language into speech output in another language have also been described. For example, U.S. Pat. No. 6,157,727 describes a hearing aid equipped with a speech translation system that converts speech signals received at an input transducer and produces speech signals in another language at the earpiece of the hearing aid. Although conventional translation systems may be able to provide reasonably quick speech-to-speech translation, it is often difficult to foresee a particular user's translation needs. Over time, a user may experience an unforeseen need for translation between languages. For example, a user of a conventional system may encounter a speaker of another language during the course of ordinary affairs. If the conventional system does not have support for the other language, the user is unable to successfully interact with the speaker of the other language. It may also be desirable not to confine the user to purchasing complex, do-it-all translation systems that have more features than necessary for the user's particular needs. Users may not desire to purchase complex systems when cost is prohibitive or the need for certain features is not immediately foreseeable.

In addition, translation systems have not been implemented in certain environments, for a variety of reasons including those discussed above. In the context of telecommunications, users are currently unable to obtain real-time translation services partly because there do not exist systems that allow for translations to occur over existing telecommunications infrastructures. Regulation of translation activity over telecommunications infrastructures may also be difficult to manage where operators of telecommunications networks require control over how translation activity is conducted over their networks. Accordingly, translation services have yet to enter into the area of real-time telecommunications.

### BRIEF DESCRIPTION OF THE DRAWINGS

FIG. 1 illustrates an example translation system, according to an example embodiment of the present invention.

FIG. 2 illustrates another example translation system, according to an example embodiment of the present invention.

FIG. 3 illustrates another example translation system, according to an example embodiment of the present invention.

FIG. 4 illustrates an example translation device, according to an example embodiment of the present invention.

FIG. 5 illustrates example configuration settings for a translation device, according to an example embodiment of the present invention.

FIG. 6 illustrates an example procedure for conducting a translation, according to an example embodiment of the present invention.

FIG. 7 illustrates another example procedure for conducting a translation, according to an example embodiment of the present invention.

FIG. 8 illustrates another example procedure for conducting a translation, according to an example embodiment of the present invention.

FIG. 9 illustrates an example procedure for registering a user with a translation service, according to an example embodiment of the present invention.

### SUMMARY

A first example embodiment of the present invention relates to a telecommunications system including first and second telecommunications devices, and a computing device. The first telecommunications device is configured to receive audio input from and deliver audio output to a first user. The second telecommunications device is configured to receive audio input from and deliver audio output to a second user. The computing device is configured to deliver a set of computer-readable instructions upon request to the second telecommunications device, the instructions configured to, when executed, convert audio input received from the first user at the first device in a first human language into audio output for delivery to the second user at the second device in a second human language, the first and second languages being different.

A second example embodiment of the present invention relates to a telecommunications system including first and second telecommunications devices, and a computing device. The first telecommunications device is configured to receive audio input from a first user and to deliver audio output to the first user. The second telecommunications device is configured to receive audio input from a second user and to deliver audio output to the second user. The computing device is in networked communication with a telecommunications provider and configured to receive audio input via the telecommunications provider from the first device in a first human language, convert the audio input into audio output in a second human language different from the first language, and deliver the second-language output via the telecommunications provider to the second device.

A third example embodiment of the present invention relates to a method for translating a first language into a second language including the steps of establishing, at a telecommunications network, a telecommunications session between a first telecommunications device and a second telecommunications device, and determining, as a function of configuration settings of the first device, one of a language spoken at the first device and a language spoken at the second device the first device language and the second device language being different. The method also includes the steps of at a computing device, translating the first device language into the second device language and outputting the translation of the first device language to the second device, and recording, in an activity log, translation activity performed by the computing device.

A fourth example embodiment of the present invention relates to an article of manufacture including a computer-readable medium having stored thereon a series of instructions executable by a processor The instructions are configured to cause the processor to perform the methods of the third example embodiment described above.

### DETAILED DESCRIPTION OF EXAMPLE EMBODIMENTS

Some example embodiments of the present invention address a need for translation systems with the capability of providing real time translation services over existing telecommunications networks. These example embodiments include systems and methods for providing automated voice translation services to users of various telecommunications devices, such as conventional telephones, mobile phones and Internet phones. The example systems and methods may also offer expandability and the ability to configure translation service according to the needs of users. In particular, some of the example embodiments include arrangements that enable users to add additional language support onto a translation device or subscribe to translation services that include additional languages. Additional services and languages may be provided with a variety of approaches, including physical add-on attachments and downloadable software modules. In the example systems, various payment schemes may be provided for compensating a provider of translation service. Payment may, for example, be based on an amount of actual usage of translation services. Other payment options are also possible.

For illustration purposes, the example embodiments will be described using the terminology of wired telephone networks. However, it will be understood that providers of translation services may be operators of any type of telecommunications network, e.g., Voice-over-IP (VoIP) and mobile phones such as those used on cellular networks, and other alternative example telecommunications networks. It will also be appreciated that the present invention is not limited to any particular type of telecommunications device or medium. Rather, the methods and systems of the present invention are media agnostic as well as encoding/voice processing agnostic. The methods and systems may be used with analog, digital, e.g., pulse code modulated or VoIP, and other types of encoding/processing.

As used throughout the specification, and except where otherwise indicated, the term “recipient” refers to a user of a telecommunications device which does not have translation service enabled by a provider. The term “user” refers to a user of a telecommunications device for which translation service is enabled. Although example embodiments will be described with reference to users initiating telecommunications sessions with recipients, it will be understood that recipients may also initiate telecommunications sessions with users. Regardless of who initiates a telecommunications session, some of the example embodiments may be used to provide automated voice translation, as will now be described.

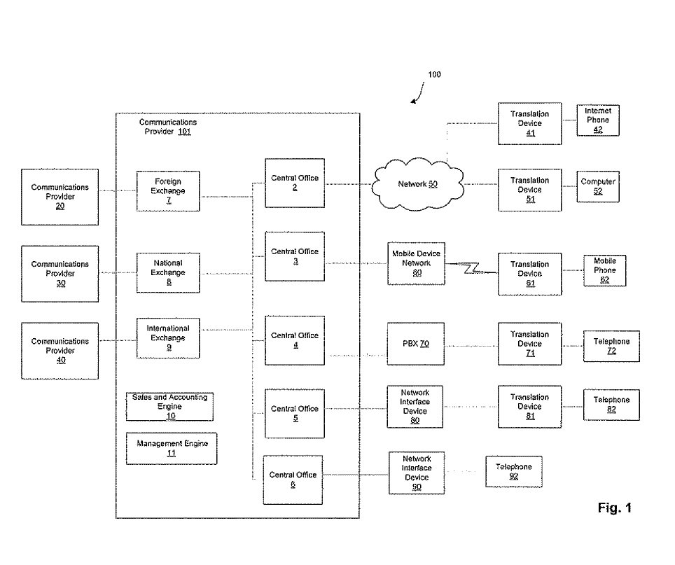

FIG. 1 illustrates an example translation system 100, according to an example embodiment of the present invention. The system 100 may include a communications provider 101 that communicates with a variety of telecommunications devices including, but not limited to, an Internet phone 42, a computer 52, a mobile phone (or any other mobile device such as a PDA, a Blackberry, an iPhone, etc.) 62, and wired telephones 72, 82 and 92. The provider 101 may include one or more central offices 2, 3, 4, 5 and 6, a foreign exchange 7, a national exchange 8, an international exchange 9, a sales and accounting engine 10, and a management engine 11. Each of the central offices 2-6 may be responsible for relaying telecommunications requests from a calling telecommunications device, e.g., users, to recipients' telecommunications devices. The example embodiment describes each central office as servicing a single device. However, other embodiments may include central offices that service multiple devices. In further embodiments, a single central office may service multiple device types, e.g., both wired telephones and mobile phones. The central offices 2-6 may be local offices of the provider 101 and function as intermediaries between a user and a local office of a recipient. Each central office 2-6 may include various combinations of hardware and/or software for handling telecommunications requests. For example, the central offices 2-6 may include switching servers and routers to direct a telecommunications request to its intended destination. In some instances, the request may be directed towards another central office. Thus, the central offices 2-6 may be in communication with each other. In other instances, the request may be directed towards a recipient outside of the immediate reach of the provider 101. Accordingly, each of the central offices 2-6 may also be in communication with the foreign exchange 7, the national exchange 8 and the international exchange 9.

The foreign exchange 7 may include connections to recipients located outside of the local calling area serviced by the central offices 2-6. The foreign exchange 7 may, for example, be in communication with another communication provider 20. It may also be possible that the provider 20 is the same as the provider 101, i.e., the provider 20 may form an extended network for the provider 101.

The national exchange 8 may include connections to recipients located in other areas, e.g., states of the same country. The national exchange 8 may be in communication with another communications provider 30. As is the case with the provider 20, the provider 30 may or may not be the same as the provider 101.

The international exchange 9 may include connections to recipients located in other countries. The international exchange 9 may be in communication with a communications provider 40. Although international providers are generally not the same as local providers, it may be possible that the provider 40 may also be the provider 101. This is particularly true in today's telecommunications systems, where many countries have provided for local loop unbundling, allowing providers to lease connections that would have otherwise been monopolized by a single local exchange provider.

The providers 20, 30 and 40 may service recipients of telecommunications requests, who operate conventional wired telephones. However, it will be appreciated that some example embodiments may allow translation to occur between users of other types of devices as well, including VoIP-enabled devices, mobile phones, radios, etc. The other devices may operate across any wired or wireless telecommunications medium including, but not limited to, satellite, high frequency radio, troposcatter radio, infrared, etc.

According to the example embodiment shown in FIG. 1, the provider 101 may provide a translation service to each of the Internet phone 42, the computer 52, the mobile phone 62 and the telephones 72 and 82. The user devices 42, 52, 62, 72 and 82 are respectively in communication with translation devices 41, 51, 61, 71 and 81. As indicated by the lack of a translation device communicating with the telephone 92, the provider 101 may also provide telecommunications service to conventional telecommunications devices without access to translation service. While actual translation may be performed at the translation devices, the provider 101 may facilitate translation by activities such as offering the translation devices for sale, providing customer service and technical support, offering accessories including add-on language modules (which will be discussed in detail below), and distributing software or firmware updates to the translation devices. The provider 101 may also track usage of the translation devices and bill the users accordingly. Any variety of payment options are possible, including one-time translation device fees, per-use fees, periodic subscription fees, based on minutes used, etc.

The translation devices 41, 51, 61, 71 and 81 may communicate with the provider 101 through a variety of arrangements suited to the particular device for which translation is provided. In an example embodiment, the translation devices may be coupled, at one end, to a telephone network-directed signal port of the user devices. At another end, the translation devices may be coupled to network devices which are in communication with the provider 101. For example, the translation devices 41 and 51 may be in communication with the central office 2 via a network 50, which may be a VoIP network or a combination of networks or sub-networks including the Internet. The translation device 61 may be in wireless communication with the central office 3 via a mobile device network 60, which may include one or more mobile device networks, cellular network exchanges, and other cellular or mobile device network components. The translation device 71 may be in communication with the central office 4 via a private branch exchange (PBX) 70 leased by a private organization from the provider 101. In another embodiment, the translation device 71 may be common equipment on PBX 70 that is shared amongst all telephones on PBX 70. The translation device 81 and the telephone 92 may respectively communicate with the central offices 5 and 6 via network interface devices 80 and 90, which define an interface between the telecommunications network of the provider 101 and the users' own telephone networks. The translation devices 41, 51, 61, 71 and 81 may communicate using the same protocols and standards as would normally be used by the user devices to communicate with the provider 101. Thus, with the exception of translation-related signals and/or data, the translation devices may appear to operate in the same manner as the user devices themselves. According to the example embodiment shown in FIG. 1, the translation devices 41, 51, 61, 71 and 81 may operate directly on voice input signals received from the input devices.

Although the translation devices 41, 51, 61, 71 and 81 have been described as hardware devices, the translation devices 41, 51, 61, 71 and 81 may be implemented in any combination of hardware and/or software. In another example embodiment, translation devices may be entirely software based, e.g., a software plug-in for an Internet phone or a cell phone. Add-on modules for translation devices may also be implemented in hardware, software, or a combination thereof.

As will be described in detail below, the provider 101 may be configured to establish communications sessions between the devices 42, 52, 62, 72, 82 and 92 and recipient devices serviced by the providers 20, 30 and 40. The provider 101 may also be configured to record translation activity for those devices which have access to a translation device, e.g., the user devices 42, 52, 62, 72 and 82. According to the example embodiments of the present invention, the recipient devices may be conventional wired telephones without access to a translation device. However, it will be appreciated that the present invention may also be implemented with virtually any telecommunications device at the recipient end. For example, the recipient device may be a VoIP-enabled device or a mobile phone. The recipient device may also have access to its own translation device and/or a separate provider of translation services.

It should be noted that according to the example embodiment shown in FIG. 1, the interaction between the user devices and the network devices is the same as though the translation devices did not exist. The translation devices 41, 51, 61, 71 and 81 may receive voice input signals from the user devices 42, 52, 62, 72 and 82 and translate them, if desired, into another language. Translated signals are presented to the network devices 50, 60, 70 and 80 as substitutes for the original voice signals. Similarly, the translation devices 41 and 51, 61, 71 and 81 may also translate voice signals received from the network devices 50, 60, 70 and 80, e.g., voice signals originating from the recipient devices, from one language to another and present the translated signals as substitutes for the original received signals. In this manner, the translation devices 41, 51, 61, 71 and 81 may be substantially invisible to both the user devices and the network devices.

The sales and accounting engine 10 may be configured to record translation activity, e.g., in a usage log stored at the provider 101. The activity may be recorded at the engine 10 itself, or transmitted to the engine 10 by, for example, the translation device. In one example, embodiment, the translation device may include a recording module configured to record the translation activity. The engine 10 may also be configured to record sales transactions, such as requests for translation devices or translation-related services. As an illustration, the sales and accounting engine 10 may include subscriber accounts corresponding to the devices 42, 52, 62, 72, 82 and 92. The subscriber accounts may indicate whether translation service has been enabled for a particular device.

The management engine 11 may be configured to provide an operator of the provider 101 with the ability to control delivery of translation services to the users. For example, the management engine 11 may be configured to allow the operator to selectively enable certain services, including translation service. The management engine 11 may also be configured to enable the operator to deliver translation device updates to the users. As will be explained below, the manner in which delivery occurs may be dependent on the nature of updates. For example, software updates may be uploaded to the provider 101 and distributed electronically to the users. Distribution may occur via the same connections and channels as those used to establish telecommunications sessions, e.g., telephone networks, the Internet, etc. Distribution may also occur through connections or channels separate from those used to establish telecommunications sessions.

In other embodiments, certain functions of the sales and accounting engine 10, e.g., sales recording, and certain functions of the management engine 11, e.g., delivery of updates, may be out-sourced to one or more third parties.

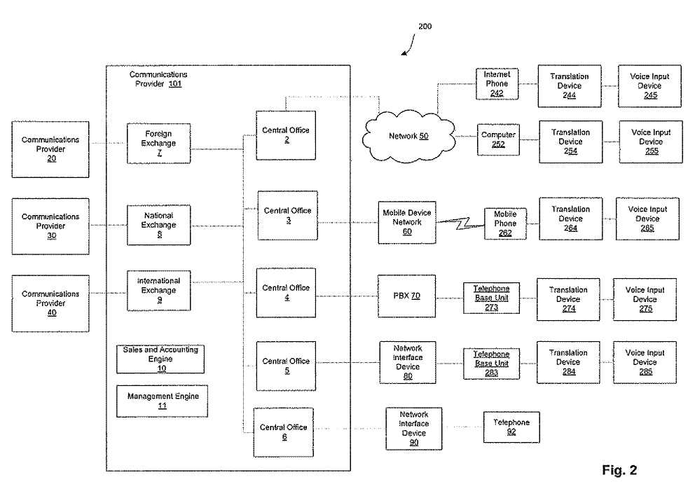

FIG. 2 illustrates an example translation system 200, according to an example embodiment of the present invention. The system 200 may include the provider 101, the providers 20, 30 and 40, and the network devices 50, 60, 70, 80 and 90 as previously described with reference to FIG. 1. As illustrated in FIG. 2, translation devices may be located at a user-directed signal port of the devices. For example, a translation device 244 may couple an Internet phone 242 to a voice input device 245, e.g., a microphone, a radio transceiver, a hands-free headset, etc. A translation device 254 may couple a computer 252 to a voice input device 255. A translation device 264 may couple a mobile phone 262 to a voice input device 265. Translation devices 274 and 284 may respectively couple telephone base units, e.g., cordless or wired phone base units, 273 and 283 to voice input devices 275 and 285. The input devices 275 and 285 may be handsets of a wired or cordless phone, or any other device capable of inputting voice signals into the base units 273, 283. According to the example embodiment shown in FIG. 2, the translation devices 244, 254, 264, 274 and 284 may operate directly on voice input signals from the input devices.

It should be noted that according to the example embodiment shown in FIG. 2, the interaction between voice input devices and the user devices may be as though the translation devices did not exist. The translation devices 244, 254, 264, 274 and 284 may receive voice input signals from the input devices and translate them, if desired, into another language. Translated signals are presented to the user devices as substitutes for the original voice signals. Similarly, the translation devices 244, 254, 264, 274 and 284 may also translate voice signals received from the user devices, e.g., voice signals originating from the recipient devices, from one language to another and present the translated signals as substitutes for the original received signals. In this manner, the translation devices 244, 254, 264, 274 and 284 may be substantially invisible to both the user devices and the voice input devices.

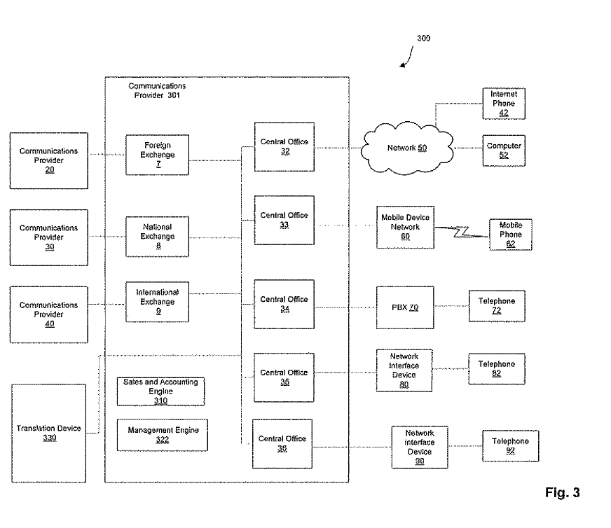

FIG. 3 illustrates an example translation system 300, according to an example embodiment of the present invention. The system 300 may include devices similar to those of the system 100, e.g., the Internet phone 42, the computer 52, the mobile phone 62 and the telephones 72, 82 and 92. The system 300 may also include the providers 20, 30 and 40, and the network devices 50, 60, 70, 80 and 90 previously discussed with reference to FIG. 1. According to the example embodiment shown in FIG. 3, a communications provider 301 may be configured to establish communications sessions between user devices, e.g., the devices 42, 52, 62, 72, 82 and 92, and recipient devices serviced by the providers 20, 30 and 40. The provider 301 may also be configured to provide translation services as previously discussed with reference to the systems 100 and 200. Unlike the example embodiments of the systems 100 and 200, the system 300 may not require a translation device to be installed directly between the user devices and the telecommunications network of the provider 301. Instead, a translation device 330 may be in networked communication with the provider 301. The translation device 330 may be configured to receive, from the provider 301, voice input signals which originate from either the recipient or the user. The translation device 330 may be any type of computing device or combination of devices, e.g., a server executing translation software, configured to provide translations at the request of the provider 301. The system 300 may be beneficial where it is undesirable or infeasible to add new hardware or software at the user end.

The provider 301 may also include the foreign exchange 7, the national exchange 8 and the international exchange. The provider 301 may further include central offices 32, 33, 34, 35 and 36, which are configured to communicate translation requests to the translation device 330. The provider 301 may also include a sales and accounting engine 310 configured to communicate with the translation device 330 and record translation activity indicated thereby. The provider 301 may also include a management engine 322 configured to control access to the translation device 330. The management engine 322 may also be configured to provide updates to the translation device 330, e.g., uploading software patches or new language modules.

The example systems described above include embodiments in which a single translation device provides translation services for a telecommunications session between a user and a recipient. It will be appreciated however, that it may also be possible for both the user and the recipient to have separate and concurrent access to a translation device, e.g., the user and the recipient may each subscribe separately to translation services of their own choosing. Thus, in other embodiments, translation devices of the user and the recipient may operate concurrently. As an illustrative example, an English-speaking user may engage in conversation with a French-speaking recipient. Both the user and the recipient may be connected to providers through a standard four-wire long haul network. A translation device at the user's side may, accordingly, be configured to utilize one pair of wires to transmit outgoing voice signals translated from English to French. Simultaneously, a translation device at the recipient's side may be configured to utilize the remaining pair of wires to transmit outgoing voice signals translated from French to English. Alternatively, the user-side translation device may be configured to translate incoming signals from French to English while the recipient-side translation device may be configured to translate incoming voice signals from English to French.

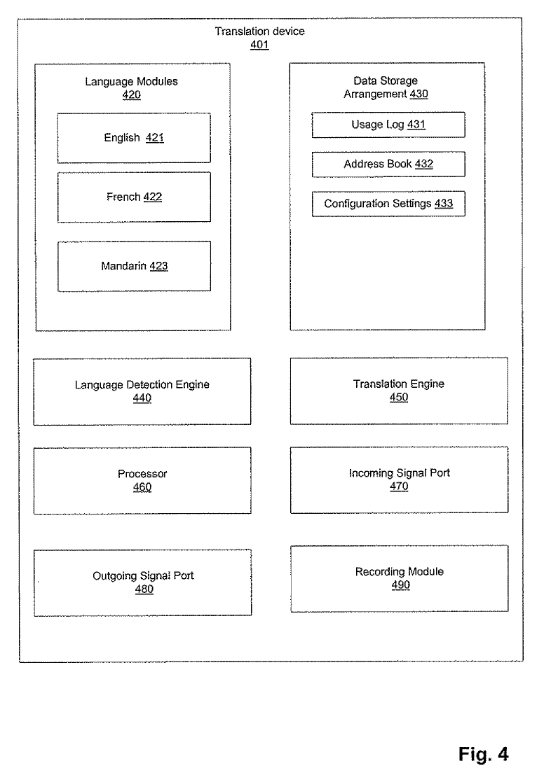

FIG. 4 illustrates an example translation device 401, according to an example embodiment of the present invention. The translation device 401 may comprise any of the translation devices discussed previously and may include one or more language modules 420, a data storage arrangement 430, a language detection engine 440, a translation engine 450, a processor 460, an incoming signal port 470, an outgoing signal port 480 and a recording module 490. The translation device 401 may be implemented in hardware, software, or any combination thereof. The modules 420 may include one or more default modules, such as an English module 421. In addition, the modules 420 may include optional add-on modules such as a French module 422 and a Mandarin module 423. The modules 420 may be located in any storage medium, such as a memory chip, a CD or DVD, a hard drive, etc. Although the example modules 422 and 423 include only a single language, other examples may include language pairs, e.g., both French and English in the same module, or multi-language sets that enable translation between the pairs/sets.

The storage arrangement 430 may be located on any storage medium and, in some example embodiments, may comprise the same storage medium as that which holds the modules 420. The storage arrangement 430 may include a usage log 431, an address book 432 and configuration settings 433. The usage log 431 may contain records of translation activity performed on behalf of user devices, e.g., the computer 52, the mobile phone 62, and the telephone 72. For example, a log entry may be created whenever a telecommunications session causes activation of the translation device.

The address book 432 may contain a list of names and/or contact information, e.g., telephone numbers, associated with the recipients. The address book 432 may enable speed dialing and caller identification, such as when the recipients initiate telecommunications sessions with the users. In addition, the address book 432 may be used to automatically configure the translation device 401, as will be discussed below.

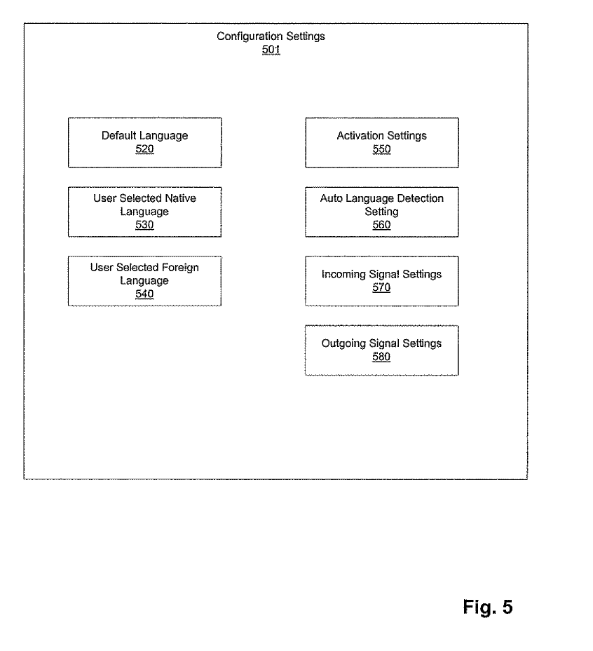

The configuration settings 433 may include any variety of manufacturer, communications provider or user specified settings. For example, referring to FIG. 5, example configuration settings 501 may include a default language 520, a user selected native language 530, a user selected foreign language 540, activation settings 550, an auto-language detection setting 560, incoming signal settings 570 and outgoing signal settings 580. The configuration settings 501 may be specified in any variety of ways, including, for example, flash programming, on-device user programming interfaces, remote programming over a computer, etc.

The default language setting 520 may correspond to a manufacturer or provider specified default language which the translation device 401 is configured to translate to if the user has not specified his own language preference. Thus, if the default language setting 520 is English, a translation device that is “straight out of the box” may be configured to automatically translate incoming voice signals into English.

The user selected native language 530 may replace the default language setting 520 by configuring the translation device 401 to translate incoming signals into the native language 530 rather than the default language 520. If the default language 520 happens to be the user's native language, the user may not specify the native language 530.

The user selected foreign language 540 may include a foreign language corresponding to a recipient. More specifically, the translation device 401 may be configured to translate incoming voice signals in the foreign language 540 into the native language 530. The translation device 401 may also be configured to translate outgoing voice signals in the native language 530 into the foreign language 540.

The activation settings 550 may specify a manner in which the user desires to activate the translation device 401. For example, the activation settings 550 may specify that the user wishes to activate the translation device 401 only for telecommunications sessions initiated by the user, only for telecommunications sessions initiated by the recipient, for all telecommunications sessions regardless of who initiates, etc. The activation settings 550 may also indicate whether the user has to enter a password in order to activate the translation device 401, who has access to the translation device 401, e.g., the provider, multiple users, a single user, etc. The activation settings may also indicate how translation is initiated. For example, translation may be initiated by pressing a certain key or combination of keys before entering in the recipient's telephone number. Translation may be initiated by calling a toll-free number and entering in a password before entering in the recipient's telephone number, e.g., a calling card PIN number. Translation may also be initiated upon receipt of an initialization signal from the provider. In another example embodiment, translation may be initiated based on the identity of the recipient. For example, if the recipient is included in the address book 432, the user may configure the translation device 401 to associate a particular language with the recipient. For example, if a particular recipient speaks French, the translation device 401 may be configured to activate translation from English to French or vice-versa each time a telecommunications session is initiated from or to that particular recipient. Other procedures for initiating translation may also be possible.

The auto language detection setting 560 may specify whether the translation device 401 should attempt to automatically detect incoming and/or outgoing voice signals and attempt to identify the language of the signals on behalf of the user. This may provide an alternative to user-specified languages and may be beneficial where the user cannot foresee the language of the recipient, or where the user speaks multiple languages.

The incoming signal settings 570 may specify whether incoming voice signals should be translated. Similarly, the outgoing signal settings 580 may specify whether outgoing voice signals should be translated. Thus, the user may select whether translation should be bi-directional or uni-directional.

Returning to FIG. 4, the language detection engine 440 may implement a language detection scheme to determine the language of an incoming or outgoing voice signals. Any conventional detection procedure may be utilized. As an illustrative example, the language detection engine 440 may be configured to break down a voice signal into smaller constituent parts, extract phonemes, pattern information and other language data, and attempt to match the language data to a human language. Alternatively, as previously discussed, language detection may be unnecessary if the recipient has an address book entry that is associated with a particular language.

It should be noted that translation from one language to another need not occur directly. In some embodiments, an intermediate language may be utilized. This may be useful where it is difficult to translate directly, e.g., because of structural differences between two languages or lack of support for translating directly between two languages. As an illustrative example, to translate from Cherokee to Icelandic, the translation engine 450 may first translate from Cherokee to English, then from English to Icelandic. Accordingly, English may be designated as an intermediate language.

The translation engine 450 may implement any conventional translation procedure for translating one spoken language to another. One example of a classical approach to speech-to-speech machine translation involves converting speech input into a source language text and translating the source language text into a target language text. Another example of speech-to-speech machine translation is the EuTrans Project, which does not adopt the classical approach. Other translation procedures are also possible and may be implemented with the example embodiments of the present invention.

The processor 460 may include one or more processing arrangements such as a microprocessor, an application-specific integrated circuit, a series of analog, digital, or mixed circuits, etc. The processor 460 may be configured to execute instructions in accordance with the translation engine 450. For example, the processor 460 may perform signal processing on incoming and/or outgoing voice signals.

The incoming signal port 470 may be a physical or virtual port by which incoming voice signals are received. The outgoing signal port 480 may be a physical or virtual port by which outgoing voice signals are sent. Examples of physical ports include, but are not limited to, USB, serial, parallel, Ethernet, and RJ11 telephone ports. Examples of virtual ports include, but are not limited to, TCP/IP and UDP ports.

The recording module 490 may be configured to record translation activity each time the translation device 401 is activated. The recorded activity may indicate any variety of usage information, such as a total amount of time spent translating, a total number of translation occurrences, languages used, telephone numbers of the user or the recipient, etc. The recording module 490 may include a memory, such as a RAM or flash memory. The memory may be of a fixed size and, in some example embodiments, may be expanded. The memory may define a limit to the amount of activity stored on the translation device 401 at any given time. Upon request from the provider, the contents of the recording module 490 may be transmitted for archiving at the provider, e.g., in the activity log.

Example procedures according to example embodiments of the present invention will now be described. The example procedures may be implemented on any of the systems previously described, i.e., the systems 100, 200 and 300. The example procedures may be provided in any combination of hardware and/or software.

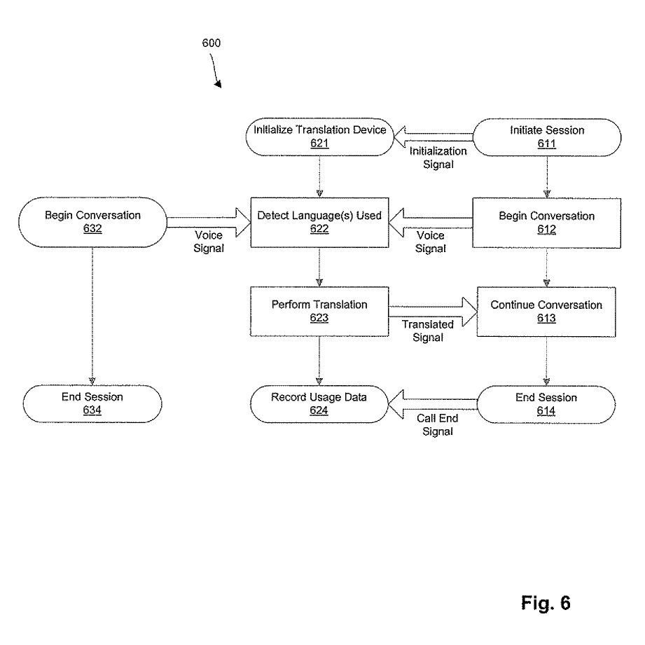

FIG. 6 illustrates an example procedure 600 for conducting a translation, according to an example embodiment of the present invention. The example procedure 600 may be provided, e.g., as software and/or hardware, in the system 100 or the system 200, but may also be implemented in other systems according the present invention. The example procedure 600 includes three separate and concurrent flows of control, one for a translation device, one for a user and one for a recipient. The user starts at 611 by initiating a telecommunications session by, for example, dialing a telephone number associated with the recipient. At this time, the user may transmit an initialization signal to the translation device. The initialization signal may be the result of any variety of actions, including picking up a telephone receiver, dialing the telephone number, pressing a button on the translation device, dialing an access number, etc.

In 621, the translation device may begin by initializing itself in response to the initialization signal, e.g., performing an initialization routine, waking up from a sleep mode, loading language modules, etc.

In 612, the user begins a conversation with the recipient. At the same time, the recipient begins the conversion in 632 by, for example, answering the phone. Voice signals from both the user and the recipient are respectively transmitted to the translation device as outgoing and incoming signals.

In 622, after receiving the incoming and outgoing voice signals, the translation device may be configured to detect languages used by the user and/or the recipient. The detection may be performed in accordance with the configuration settings previously described. Detection is optional, and in some embodiments, may not occur, e.g., when the recipient has an address book entry.

In 623, the translation device performs translation in accordance with the translation engine and the configuration settings specified by the user. As an illustrative example, the recipient may be speaking French and the user may be speaking English. The user may have specified that translation only occur at the incoming side of the conversation. Accordingly, the translation device may translate from French to English and present translated voice signals in English to the user.

In 613, the user continues his conversation while being presented with the translated voice signals as substitutes for the incoming voice signals.

In 614, the user ends his conversation by, for example, hanging up the phone. Upon ending the conversation, a “Call End” signal is transmitted to the translation device. This may be an actual signal, e.g., an end of transmission signal. Alternatively, the translation device may be configured to detect the end of the conversation, e.g., based on a lack of outgoing voice signals. At the same time, the recipient may end the call session in 634 by, for example, hanging up the phone. Although a Call End signal may not be transmitted from the recipient, in alternative example embodiments, the translation device may wait for an indication that both the user and the recipient have completed their conversation before proceeding.

In 624, usage data indicating usage of translation services is recorded by, for example, the translation device. The usage data may later be transmitted to the provider electronically for billing, record-keeping purposes, and other purposes. Alternatively, the usage data may be read from a recording device by an agent of the provider, e.g., a meter reading.

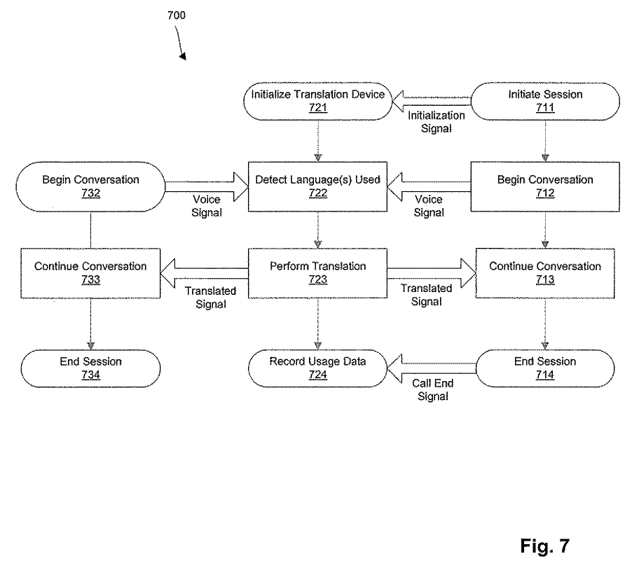

FIG. 7 illustrates an example procedure 700 for conducting a translation, according to an example embodiment of the present invention. The procedure 700 may be provided, e.g., as software and/or hardware, in the system 100 or the system 200, but may also be implemented in other systems according the present invention. Portions of the example procedure 700 may be substantially similar to those described with reference to the procedure 600. The establishing of the telecommunications session and the automatic detection of languages may be performed in a similar fashion as previously described in the procedure 600. For instance, in 711 the user initiates a telecommunications session and the translation device is initialized in 721. In 712 and 732, the user and the recipient respectively begin their conversation. In 722 the translation device may perform automatic language detection.

In 723, the translation device may perform translation. The user and the recipient may respectively continue their conversation in 713 and 733. In contrast to the uni-directional translation described with reference to the procedure 600, the translation device may perform bi-directional translation. For example, the translation device may translate outgoing signals from English to French in addition to translating incoming signals from French to English.

In 714 and 734, the user and the recipient respectively end their conversation. The translation device may then record the usage data in 724.

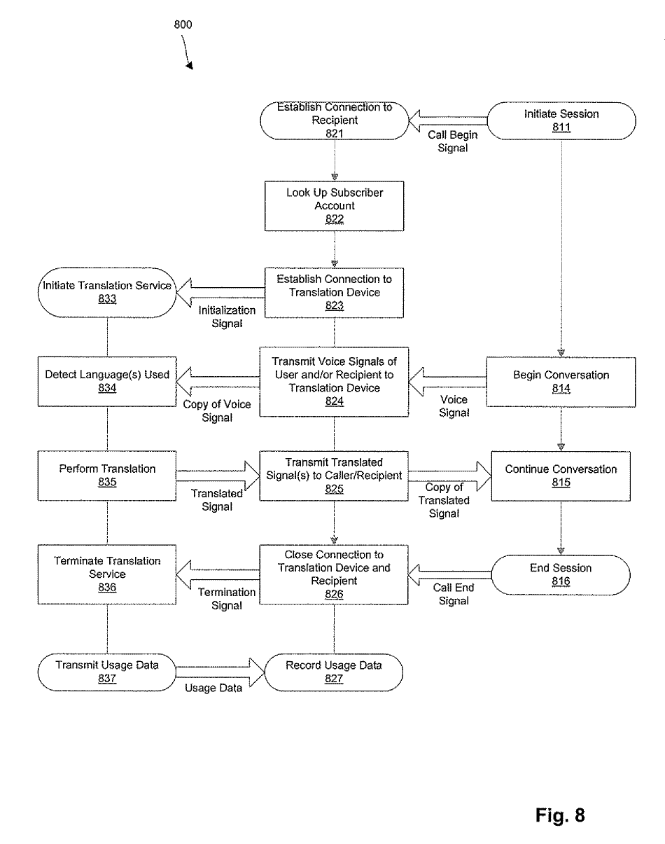

FIG. 8 illustrates an example procedure 800 for conducting a translation, according to an example embodiment of the present invention. The example procedure 800 may be provided, e.g., as software and/or hardware, in the system 300, but may also be implemented in other systems according to the present invention. The example procedure 800 includes three separate and concurrent flows of control, one for a translation device (e.g., the translation device 330), one for a provider (e.g., the provider 301) and one for a user. The user starts at 811 by initiating a telecommunications session. A “Call Begin” signal may be transmitted to the provider 301.

In 821, the provider 301 receives the Call Begin signal and establishes a connection to the recipient (not shown), who may choose to accept the telecommunications session and engage the user in conversation.

In 822, the provider 301 performs a lookup of a subscriber account associated with the user. The lookup may be identification based, for example, based on the user's telephone number, IP address, etc. After it is verified that the user has an account and that the account indicates translation service has been subscribed to or purchased, the lookup is complete.

In 823, the provider 301 has located the subscriber account and determined, based on information in the account, that the user is authorized to receive translation services. Accordingly, the provider 301 may establish a connection to the translation device 330. An initialization signal may be transmitted to the translation device 330, which initiates a translation service in 833.

In 814, the user begins a conversation with the recipient, causing voice signals to be transmitted to the provider 301. In 824, the provider 301 may transmit a copy of the voice signals of the user and/or the recipient to the translation device 330. The provider 301 may pass a copy which is identical to the original voice signals, or may optionally perform signal processing, e.g., filtering or formatting prior to transmitting the copy to the translation device 330.

In 834, the translation device 330 may, depending on how it has been configured, detect one or more languages used by the user and/or the recipient.

In 835, the translation device 330 performs translation upon the voice signal(s) in accordance with configuration settings, e.g., translation uni-directionally or bi-directionally, and transmits the translated signals to the provider 301. In 825, the provider 301 transmits a copy of the translated signals to the recipient and/or the user, who continues the conversation in 815.

In 816, the user ends the telecommunications session and transmits a Call End signal to the provider 301. In response, the provider 301, in 826, may close the connection to the translation device 330 and the connection to the recipient. A termination signal may be transmitted to the translation device 330.

In 836, the translation device 330 may terminate translation service by, for example, deactivating itself.

In 837, the translation device 330 may transmit usage data to the provider 301, who, in 827, records the usage data.

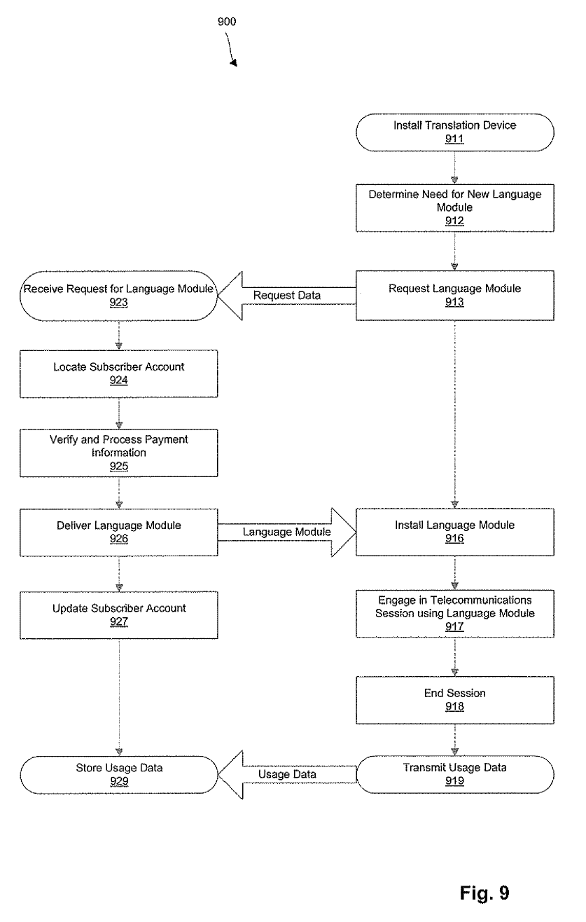

FIG. 9 illustrates an example of a procedure 900 for registering a user with a translation service, according to an example embodiment of the present invention. The example procedure 900 may be provided, e.g., as software and/or hardware, in any of the systems described previously. The example procedure 900 includes two separate and concurrent flows of control, one for a user and one for a provider. Generally, the procedure 900 describes upgrading a translation device by adding support for translation of additional languages. The procedure 900 also relates to configuring a user's subscription to translation services. In 911, a translation device is installed. Depending on the particular system, the translation device may be installed at the site of the user (e.g., attaching the translation device to the user's phone or computer) or at a remote site accessible to the provider (e.g., the translation device 330).

In 912, a need for a new language module is determined. This may occur as a user determination, or a machine determination (e.g., by the translation device, in response to recognizing an unsupported language during the course of a telecommunications session). The determination may occur at any time including, but not limited to, after purchasing the translation device, before purchasing the translation device, during a telecommunications session and after a telecommunications session.

In 913, a new language module may be requested. The request data may be transmitted to the provider or an agent thereof. The request may be in the context of a retail sale of a language module. The sale may occur in person or electronically, e.g., over the phone, the Internet, etc.

In 923, the request for the language module may be received. Responsive to the request, the provider may prepare to process the request.

In 924, a subscriber account may be located for the user. If an account does not exist, a new account may be created and made accessible to the provider.

In 925, payment information may be verified, e.g., with a credit card agency or bank. Payment may then be processed, e.g., by debiting a prepaid account or by generating a charge against a credit account.

In 926, payment has been processed and received by the provider, who then delivers the language module to the user. The delivery may also be electronic, e.g., downloaded directly, as a software plug-in, to the translation device or the user's device. Alternatively, the delivery may involve delivering a physical object such as a memory chip, a software CD, an attachment device, etc.

In 927, the subscriber account may be updated to reflect the payment and/or delivery.

In 916, the language module may be installed. A hardware and/or software installation, or a combination thereof, may be used.

In 917, the user engages in a telecommunications session using the language module. The session may be a new session such as when the user places a call at a time after the language module is installed. The session may also be a resumed session which was interrupted so that the language module could be delivered and installed. Some time later, in 918, the telecommunications session may end, e.g., by being terminated by the user.

In 919, following the ending of the telecommunications session, usage data may be transmitted to the provider. The transmission may be from any device recording the usage data such as, for example, the telecommunications device.

In 929, the usage data is stored, e.g., at the provider. Subsequently, the user may be billed for the usage of the translation device, either for translation service in general, or for translation services involving use of the newly installed language module.

Although the example embodiments have been described with reference to providing real-time translation services, other services may also be possible. As an example, the translation device may record a translated conversation as it occurs, then transmit the conversation to a terminal device or central server for archiving. The user may, at a subsequent time, retrieve the translation, either as an audio recording or a text transcript. The user may be provided with the option to retrieve un-translated portions of a conversation, e.g., the original voice signals as presented to the translation device, prior to translation, in addition to retrieving the translation. The provider may offer this service for an additional charge.

The recorded conversation may be secured against unauthorized access and made available only to the provider and, upon granting of access by the provider, to the user. Access may also be granted to third parties, e.g., others to whom the user has provided access information such as a password for accessing the recorded conversation. In one example embodiment, the recorded conversation may be played through the user's own device. If the recorded conversation is an audio recording, the user may listen to the recording in a manner similar to that of playing a voicemail message. If the recorded conversation is a text transcript, the user may request a hard copy by mail or an electronic copy accessible through, for example, email, a Web interface, fax, etc.

In some embodiments, the translation device may be configured to convert the audio recording to text format, e.g., speech-to-text, as an additional translation service. Similarly, in another example embodiment, the translation device may be configured to convert the text transcript to speech. In further embodiments, the translation device may be configured to convert speech directly to text displayed to the user in realtime. The translation device may also be configured to convert text-to-speech, e.g., the user may input text in one language and the text may be converted into audio in another language. In still further embodiments, the translation device may be configured to convert directly from text-to-text, e.g., text in one language may be converted in real-time into text in another language. Conversion according to these additional embodiments, each of which may involve manipulation of text data, may be performed using any number of systems, devices or techniques, all of which would be known to those skilled in the art.

Access to the recorded conversation may be made available based on any variety of payment arrangements. In some example embodiments, the provider may provide unlimited, lifetime access in return for a one-time fee. Other example embodiments include limited duration access. In some instances, the duration may be limited because the provider has chosen to provide access for a fixed period of time for each payment. In other instances, the duration may be limited because the provider has chosen not to store the recorded conversation indefinitely, e.g., each record may have a fixed retention time before being erased.

It will be appreciated that all of the disclosed methods and systems described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A telecommunications system, comprising:
a first telecommunications device configured to receive audio input from and deliver audio output to a first user;
a second telecommunications device configured to receive audio input from and deliver audio output to a second user;
a computing device configured to deliver a set of computer-readable instructions upon request to the second telecommunications device, the instructions configured to, when executed, convert audio input received from the first user at the first device in a first human language into audio output for delivery to the second user at the second device in a second human language, the first and second languages being different.

2. The telecommunications system of claim 1, wherein the instructions are delivered over a telecommunications network.

3. The telecommunications system of claim 2, wherein the telecommunications network includes at least one of the Internet, a public switched network, a private wireless network and a private wired network.

4. The telecommunications system of claim 1, wherein the instructions are delivered as a physical accessory module, the accessory module including an attachment arrangement for physically coupling to the computing device.

5. The telecommunications system of claim 1, wherein the computing device couples a telephone network-directed signal port of the second device to a transmission medium over which communication between the first and second devices occurs.

6. The telecommunications system of claim 1, wherein the computing device couples a peripheral device to a user-directed signal port of the second device.

7. The telecommunications system of claim 1, wherein:
the computing device includes a processor configured to automatically detect one of the first device language and the second device language.

8. The telecommunications system of claim 1, wherein:
the computing device is configured to automatically determine, based on a stored record associated with an operator of the second device, the second device language.

9. The telecommunications system of claim 1, wherein:
the computing device is configured to determine that translation is unsupported for one of the first device language and the second device language; and
the computing device is configured to, in response to the determination, generate a request for additional language support.

10. The telecommunications system of claim 9, wherein:
the additional language support is implemented by installing a language module at the computing device.

11. The telecommunications system of claim 10, wherein the language module is implemented as a software plug-in.

12. The telecommunications system of claim 1, wherein:
the computing device is configured to monitor and record usage of the instructions by the second device.

13. The telecommunications system of claim 12, wherein:
a telecommunications provider associated with the computing device is configured to generate, using an accounting engine, a bill for the second user based on the recorded usage.

14. The telecommunications system of claim 1, wherein:
the computing device is configured to store a record of a telecommunications session between the first and second users, the record including a translated portion of a conversation occurring during the telecommunications session.

15. The telecommunications system of claim 14, wherein:
a telecommunications provider associated with the computing device is configured to provide one of the first and the second user with access to the record.

16. The telecommunications system of claim 1, wherein:
the computing device is configured to generate a record of a telecommunications session between the first and the second user, the record including an un-translated portion of a conversation occurring during the telecommunications session.

17. The telecommunications system of claim 16, wherein:
a telecommunications provider associated with the computing device is configured to provide one of the first and the second user with access to the record.

18. The telecommunications system of claim 1, wherein the first device language is converted into an intermediary language, which is then converted into the second device language.

19. The telecommunications system of claim 1, wherein the computing device is implemented as a software plug-in.

20. A telecommunications system, comprising:
a first telecommunications device configured to receive audio input from a first user and to deliver audio output to the first user;
a second telecommunications device configured to receive audio input from a second user and to deliver audio output to the second user;
a computing device in networked communication with a telecommunications provider, the computing device configured to receive audio input via the telecommunications provider from the first device in a first human language, convert the audio input into audio output in a second human language different from the first language, and deliver the second-language output via the telecommunications provider to the second device.

21. The telecommunications system of claim 20, wherein
the first device language is converted into an intermediary language, which is then converted into the second device language.

22. The telecommunications system of claim 20, wherein the telecommunications provider is configured to generate a bill for one of the first user and the second user based on usage of the computing device.

23. A method for translating a first language into a second language comprising:
establishing, at a telecommunications network, a telecommunications session between a first telecommunications device and a second telecommunications device;
determining, as a function of configuration settings of the first device, one of a language spoken at the first device and a language spoken at the second device, the first device language and the second device language being different;
at a computing device, translating the first device language into the second device language and outputting the translation of the first device language to the second device; and
recording, in an activity log, translation activity performed by the computing device.

24. The method of claim 23, wherein the computing device is remotely located from the first and second devices.

25. The method of claim 24, wherein the computing device is a server in networked communication with the telecommunications network.

26. The method of claim 23, wherein the computing device couples a telecommunications network-directed signal port of the second device to a transmission medium over which the telecommunications session occurs.

27. The method of claim 23, wherein the computing device couples a peripheral device to a user-directed signal port of the second device.

28. The method of claim 23, further comprising:
at the computing device, translating the second device language into the first device language and outputting the translation of the second device language to the first device.

29. The method of claim 23, further comprising:
automatically detecting one of the first device language and the second device language using a processor of the computing device.

30. The method of claim 23, further comprising:
at the computing device, automatically determining, based on a stored record associated with an operator of the second device, the second device language.

31. The method of claim 23, further comprising:
at the computing device, determining that translation is unsupported for one of the first device language and the second device language; and
generating a request for additional language support.

32. The method of claim 31, further comprising:
implementing the additional language support by installing a language module at the computing device.

33. The method of claim 23, further comprising:
at an accounting engine of a telecommunications provider associated with the computing device, generating a bill for a user of the second device based on the recorded activity.

34. The method of claim 23, further comprising:
storing a record of the telecommunications session using a recording module of the computing device, the record including a translated portion of a conversation occurring during the telecommunications session.

35. The method of claim 34, further comprising:
at a telecommunications provider associated with the computing device, providing a user of one of the first device and the second device with access to the record.

36. The method of claim 23, further comprising:
storing a record of the telecommunications session using a recording module of the computing device, the record including an untranslated portion of a conversation occurring during the telecommunications session.

37. The method of claim 36, further comprising:
at a telecommunications provider associated with the computing device, providing a user of one of the first device and the second device with access to the record.

38. The method of claim 23, further comprising:
translating the first device language into the second device language by translating the first device language into an intermediary language and then translating the intermediary language into the second language.

39. An article of manufacture comprising a computer-readable medium having stored thereon a series of instructions executable by a processor, the instructions configured to cause the processor to perform the methods of any of the preceding method claims.
